(19) United States
(12) Patent Application Publication
(10) Pub. No.: US 2012/0290916 A1
(43) Pub. Date: Nov. 15, 2012

(54) UNIFIED FILE ARRANGEMENTS

(76) Inventors: Neel B. Parekh, Sunnyvale, CA (US); Emmanuel R. Saint-Loubert-Bie, Redwood City, CA (US); Renaud-Roland Hubert, Gilroy, CA (US); Jeffrey D. Yaksick, Mount Hamilton, CA (US); Paul Joyce, Menlo Park, CA (US); Dmitry Dolinsky, San Francisco, CA (US)

(21) Appl. No.: 13/465,109

(22) Filed: May 7, 2012

Related U.S. Application Data
(60) Provisional application No. 61/484,127, filed on May 9, 2011.

(51) Int. Cl. G06F 17/00

(52) U.S. Cl. 715/234; 715/273

(57) ABSTRACT

In general, a method includes receiving a request to present a file inventory on a display associated with the computing device, the file inventory graphically representing a plurality of files stored across two or more physical locations, accessing a first file stored on a local storage device of the computing device to record first information associated with the first file, accessing a second file stored on a remote storage device to record second information associated with the second file, generating the file inventory, the file inventory including the first information and the second information, and presenting the file inventory on the display.

### CROSS-REFERENCE TO RELATED APPLICATIONS

This application claims priority to U.S. Provisional Application Ser. No. 61/484,127, filed on May 9, 2011, entitled “UNIFIED FILE ARRANGEMENTS,” the entire contents of which are hereby incorporated by reference.

### BACKGROUND

Electronic storage devices can be used to store information in the form of files. Users or applications can access files stored on storage devices in order to interact with the information stored in the file. In some cases, files may be stored in more than one device, including in devices that are located remotely from a computing device attempting to access the files.

### SUMMARY

In general, in one aspect, a method includes receiving a request to present a file inventory on a display associated with the computing device, the file inventory graphically representing a plurality of files stored across two or more physical locations, accessing a first file stored on a local storage device of the computing device to record first information associated with the first file, accessing a second file stored on a remote storage device to record second information associated with the second file, generating the file inventory, the file inventory including the first information and the second information, and presenting the file inventory on the display.

In general, in another aspect, a method includes receiving a request to present a file inventory on a display associated with the computing device, the file inventory graphically representing a plurality of files stored across two or more physical locations, accessing one or more index files that includes first information associated with a one or more first files stored on a local storage device and second information associated with one or more second files stored on a remote storage device, recording the first information and the second information, generating the file inventory, the file inventory including the first information and the second information, and presenting the file inventory on the display.

In general, in another aspect,a method is performed on a computing device that includes one or more processing devices and one or more local memory devices. The method includes receiving, by the one or more processing devices, a request to present a file inventory on a display associated with the computing device, the file inventory being stored on the one or more local memory devices, and being based on first information associated with a first file stored on the one or more local storage devices and second information associated with a second file stored on a remote storage device, the file inventory graphically representing a plurality of files stored across two or more physical locations, and presenting the file inventory on the display in response to the request.

Aspects may include one or more of the following features.

Accessing the second file includes accessing the remote storage device over a network.

A third file stored on the remote storage device is accessed to record third information associated with the third file.

The first information and the third information are compared to determine a level of similarity between the first file and the third file.

It is determined that the level of similarity exceeds a threshold, and one or more attributes of the first file are evaluated against one or more attributes of the third file based on the level of similarity.

The third information is excluded from the file inventory based on the evaluating.

The one or more attributes include one or more of: respective speeds with which the first file and the third file can be accessed by the computing device, respective data qualities of the first file and the third file, respective recencies of the first file and the third file, and respective frequencies with which the first file and the third file are accessed.

The evaluating includes determining that the computing device is able to access the first file more quickly than the computing device is able to access the third file.

The computing device is caused to access the first file based on a selection of the first information in the file inventory, the selection including an instruction to provide content associated with the first file.

The first file and the second file include music files, video files, image files, and document files.

The first file and the second file are music files, and the data inventory includes a library of songs.

The one or more index files include one or more extensible markup language (XML) files.

Other embodiments of these aspects include corresponding systems, apparatus, and computer programs, configured to perform the actions of the methods, encoded on computer storage devices.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a diagram of a file storage system.

FIG. 2 is a flow chart of possible process for presenting a file inventory.

FIG. 3 is a diagram of a user interface.

FIG. 4 is a diagram of a computing system.

Like reference symbols in the various drawings indicate like elements.

### DETAILED DESCRIPTION

Briefly, techniques are disclosed for providing a unified view of, and/or unified access to, a group of files that is stored across two or more locations. For example, a single list of files (sometimes referred to as a file inventory) can be generated and displayed on a user device such as a mobile smartphone that identifies (e.g., graphically represents the identities of) the files stored across the multiple storage locations. In some examples, the file inventory can be a “flat” file structure, in which the file identities are listed as if they are located within the same hierarchical level of the same storage device. For example, two files that are stored on separate devices (e.g., with one file being stored on a local hard drive and the other file being stored on a remote storage device, such as a remote server) can be listed in the file inventory as if both were stored on the local storage device.

These techniques allow an entire library of files to be presented to a user regardless of where the files are physically stored. Rules and logic can be implemented to handle access and presentation of content that is stored on two or more different storage devices (e.g., duplicate files).

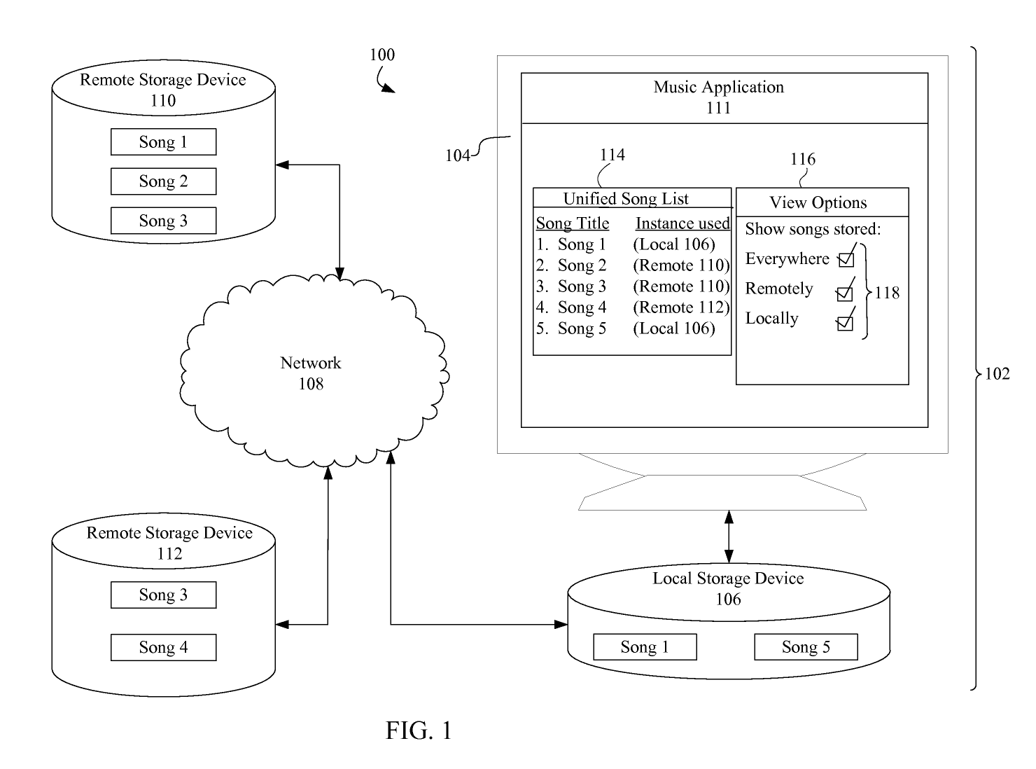

FIG. 1 illustrates an example of a system 100 that includes a computing device 102 (e.g., a personal computer or a mobile device, such as a smart phone) that includes a local storage device 106 (e.g., internal memory, such as an internal hard drive or a local solid state storage device) and a display device 104, such as a monitor, liquid crystal display (LCD) screen, or a touchscreen. The computing device 102 communicates over a network 108 (e.g., the Internet and/or one or more additional local area networks (LANs) or wide area networks (WANs)) with a first remote storage device 110 and a second remote storage location 112. In some examples, the remote storage devices 110, 112 can collectively be referred to as “cloud storage” or simply “the cloud.” Any of the storage devices shown in FIG. 1 may include one or more storage devices, such as a server with multiple hard drives or a cluster of servers.

The local storage device 106 and the remote storage devices 110, 112 are capable of storing a variety of file and data types. For example, the storage devices 106, 110, 112 can store files and data including image files (e.g., pictures), video files (e.g., movie clips), documents, spreadsheets, and/or any other suitable file type. In FIG. 1, by way of example only, the local storage device 106 and the remote storage devices 108, 110 store music files (e.g., sometimes referred to as songs, such as song 1 stored in the remote storage device 110) that can be accessed by the computing device 102.

The computing device 102 may include one or more applications that can be executed to access, view, modify, or otherwise interact with the songs stored on both the local storage device 106 and the remote storage devices 110, 112, such as a music application 111. Specifically, in the example of FIG. 1, the local storage device 106 stores song 1 and song 5, the remote storage device 110 stores song 1, song 2, and song 3, and the remote storage device 112 stores song 3 and song 4. An example of the music application 111 is a music player application that can access a music file (e.g., song 1 on the local storage device) in order to effect auditory playback of the contents of the music file. The music application 111 may provide output signals to one or more speakers that represent the content of a particular music file so that a user can, for example, listen to music associated with the music file.

The music application 111 may also provide output signals that are graphically presented on the display 104 associated with the computing device 102. For example, the music application 111 can include information associated with a song that it is currently playing (e.g., one or more of an artist name, a song title, an album name, a song duration, a song progress indicator), as well as one or more controls that affect the playback or presentation of music data. Some of these features are described in further detail below.

In some examples, a user of the computing device 102 may wish to view some or all of the songs that can be accessed by the computing device 102, regardless of whether the songs are stored on the local storage device 106 or on the remote storage devices 110, 112. Accordingly, a unified song list 114 can be provided on the display device 104 of the computing device 102 that presents a list of the songs that the computing device 102 can access. The unified song list 114 is an example of the file directory described above, and includes graphical representations of song 1 (stored on both the local storage device 106 and the remote storage device 110, song 2 (stored on the remote storage device 110), song 3 (stored on both the remote storage device 110 and the remote storage device 112), song 4 (stored on the remote storage device 112), and song 5 (stored on the local storage device 106).

In some examples, the unified song list 114 can present the songs in a manner that hides or suppresses any duplicate songs (e.g., song 1, which is stored on two different storage devices). For example, to present an orderly view of a user's music library, the unified song list 114 presents only one instance of song 1 even though the computing device 102 has access to a first instance of song 1 on the local storage device 106 and a second instance of song 1 on the remote storage device 110. In some examples, the unified song list 114 can provide some visual indication that more than one instance of a song can be accessed by the computing device 102 (e.g., an asterisks could be placed near the graphical representation of song 1, such as in *Song 1).

In some examples, the music application 111 may designate a single instance of a duplicate song as the song instance that will be played back upon selection by a user in the unified song list 114. For example, although song 1 is stored on both the local storage device 106 and the remote storage device 110, only one instance of song 1 is presented in the unified song list 114. In addition, if a user activates song 1 for playback (e.g., by touching a region of a touchscreen near the “song 1” text presented in the unified song list), the music application 111 may automatically initiate playback of the instance of song 1 stored on the local storage device (and not the same song 1 stored on the remote storage location 110). The music application 111 may also provide an indication of which song instance has been designated for playback (e.g., the “instance used” indication shown in the unified song list 114). Similarly, if a song is stored both the remote storage device 108 and the remote storage device 110, the music application 111 may designate one of the instances as the song instance that will be played back upon selection by a user in the unified song list 114.

While in some examples the music application 111 may provide controls that allow a user to specify which instance of a song will be used for playback when duplicate instances are stored, the music application 111 may also designate song instances for playback based on one or more rules. For example, the music application 111 may automatically designate song 1 stored on the local storage device 106 as the instance for playback based on a determination that the local storage device 106 is likely to provide faster data transfer speeds than a remotely located storage device, such as remote storage location 110. The music application 111 may also designate a particular song instance for playback based on one or more other factors, such as which instance of the song is of a higher data quality (e.g., which version of the song can be played at the highest bit rate), which instance of the song is the most recent, or which instance of the song is most frequently accessed by a user or by other applications.

The music application 111 may also include view options 116. In some examples, the view options 116 include one or more filter controls 118 that allow a user to specify the storage locations from which files should be presented in the unified song list 114. For example, if only the “locally” control is activated in the view options 116, the unified song list 114 will only present songs stored on the local storage device 106 (e.g., song 1 and song 5). In the example of FIG. 1, the “everywhere” control has been activated, which may automatically activate the control associated with each storage location. As a result, the unified song list 114 would include songs stored in any appropriate location accessible to the computing device 102. The view options 116 may also include controls for selecting specific storage locations. For example, the filter controls 118 may include controls that allow for the specific selection of the remote storage device 110, the remote storage device 112, and/or the local storage device 106.

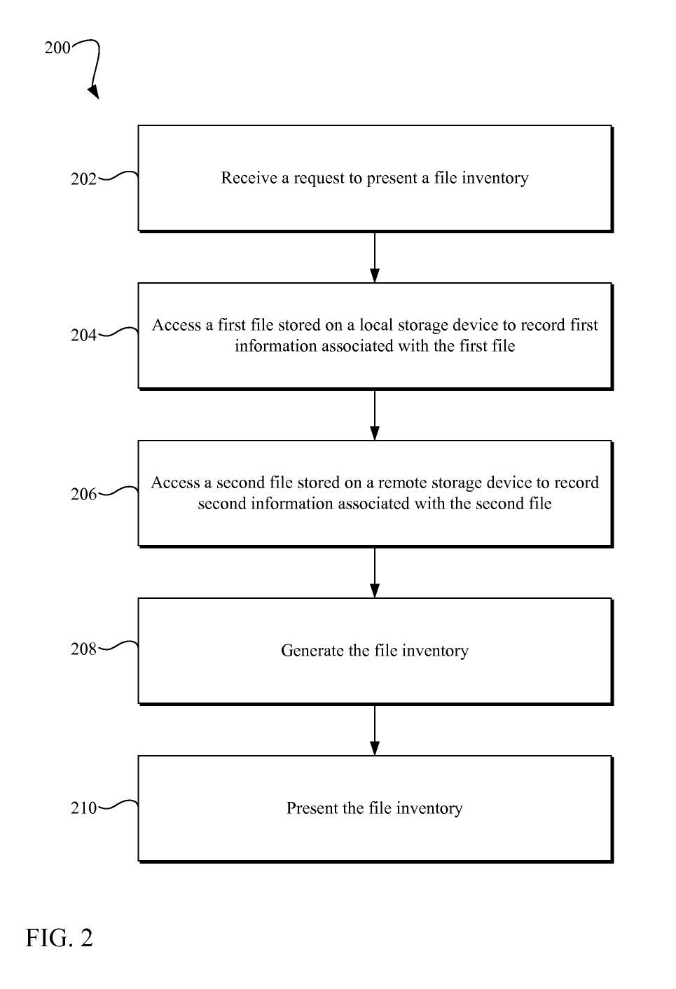

FIG. 2 is an example of a process 200 for presenting a file inventory (e.g., the unified song list 114). A request is received to present a file inventory (202). For example, the computing device 102 may receive a command from a user to start and open the music application 111 so that the user can be presented with a list of songs which he can play in the music application 111. In some examples, the file inventory graphically represents a plurality of files stored across two or more physical locations, and may resemble a list of files.

A first file stored on a local storage device is accessed to record first information associated with the first file (204). For example, in order to generate a file inventory, the music application 111 may access a local storage device (e.g., internal memory on a smartphone, if the music application is running on that smartphone) in order to assess and record information related to a first song, such as the name of the song, the location (e.g., the file path) where the song is stored, the song's artist, the song's album, a date the song file was created and/or modified, a data quality of the song file (e.g., a bitrate associated with the song), and other information. The first information can be saved to a local storage device so that the music application 111 only has to check for updates to the stored information in order to generate future file inventories.

A second file stored on a remote storage device is accessed to record second information associated with the second file (206). For example, in order to generate a file inventory, the music application 111 may access a remote storage device (e.g., a remote server located behind a network, such as the Internet) in order to assess and record information related to a second song, such as the name of the song, the location (e.g., the file path) where the song is stored, the song's artist, the song's album, a date the song file was created and/or modified, a data quality of the song file (e.g., a bitrate associated with the song), and other information. The second information can be saved to a local storage device so that the music application 111 only has to check for updates to the stored information in order to generate future file inventories.

The file inventory is generated (208). For example, the music application 111 can generate a file inventory that includes the first information and the second information. For example, using the first and second information described above, the music application 111 can generate a file inventory that includes a first song and a second song, even though the songs are stored on physically separate devices. A state of the file inventory can be saved so that the music application 111 only needs to update the saved file inventory in order to generate future file inventories.

The file inventory is presented (210). For example, the music application 111 can cause the generated file inventory to be displayed on a display device, such as a touchscreen of a mobile smartphone. The file inventory may include a graphical representation of the files that it includes. For example, a file inventory may include, for each of the songs included in the file inventory, text (e.g., a song title and artist name) and/or an image data (e.g., album artwork) that is associated with the song.

Assuming for this example that the files are song files, in some examples, the music application 111 may determine that a song instance is a substantial duplicate of another song instance that is accessible to the music application 111. To reach this determination, the music application 111 may compare information associated with two or more songs in order to determine a level of similarity between the songs. If the music application 111 determines that two song instances have a level of similarity that is above a threshold value, the song instances can be identified as duplicates. For example, the music application 111 may identify two song instances as duplicates if their associated information indicates that the song instances have the same artist, title, and album. The music application 111 may also compare other information, such as a file checksum, a file hash code, or other file metadata including song length, idv3 data, track start times, acoustic fingerprint, and others.

Upon determining the existence of duplicate song instances, the music application 111 may designate one of the song instances as the song instance that will be played back upon selection by a user in the file inventory. While in some examples the music application 111 may provide controls that allow a user to specify which instance of a song will be used for playback when duplicate instances are stored, the music application 111 may also designate song instances for playback based on one or more rules. For example, the music application 111 may automatically designate song 1 sored on the local storage device 106 as the instance for playback based on a determination that the local storage device 106 is likely to provide faster data transfer speeds than a remotely located storage device, such as remote storage location 110. The music application 111 may also designate a particular song instance for playback based on one or more other factors, such as which instance of the song is of a higher data quality (e.g., which version of the song can be played at the highest bit rate), which instance of the song is the most recent (e.g., file recency), or which instance of the song is most frequently accessed by a user or by other applications.

In some examples, a file inventory can be generated based on information obtained from a file other than the source file that will be graphically represented in the file inventory. For example, instead of (or in addition to) accessing each individual song file stored on a local storage device to obtain information associated with the song, the music application 111 could access a file that includes information associated with one or more song files. For example, the music application 111 could access an extensible markup language (XML) file that includes meta information associated with a plurality of songs stored on a storage device. These techniques can lower the resource cost of obtaining file information for use in the file inventory.

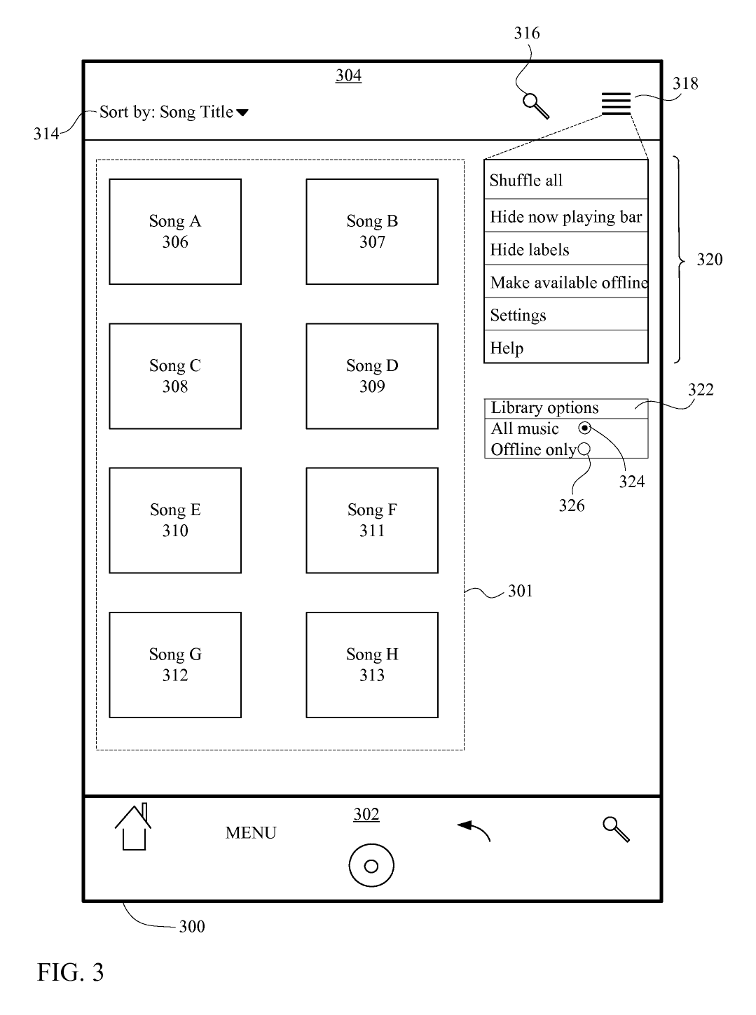

FIG. 3 illustrates a mobile device 300 (e.g., a mobile smartphone) that includes a control panel 302 and a display 304. The control panel 302 may include one or more hard keys for inputting commands to the mobile device, and the display 304 may provide visual output to a user from one or more operations executed on the mobile device 300. In this example, the display 304 displays information associated with the output of a music application, such as the music application 111 described above. As a result of operations performed by the music application running on the mobile device 300, the display 304 provides a venue for a user to view and interact with music data stored across multiple storage devices (e.g., both local and remote storage devices).

In association with the music application, the mobile device 300 provides, on the display 304, a file inventory 301 that lists (e.g., by graphically representing) songs 306-313. In some examples, a user of the mobile device 300 may initiate playback of one of the songs 306-313 by touching a region of the display 304 near the graphical representation of the desired song. Playback can occur in the same screen, or a new screen can be generated on the display 304.

The display 304 includes controls for interacting with song files accessible to the mobile device 300. For example, the display 304 provides a sort control 314 for sorting songs based on one or more attributes, such as a song title (as shown), a song artist, a song album, and other attributes. The display 304 also includes a search control 316 for allowing users to search for songs using keywords or one or more predefined search options. The display 304 further includes a main settings control 318 that includes a variety of sub-options 320.

A view control 322 includes filters 324, 326 for altering which data source(s) will be used to populate songs to the file inventory 301. In this example the filter 324 has been selected to populate the file inventory 301 with songs from all storage devices that are accessible to the mobile device 300. Selection of the filter 326 may cause the file inventory 301 to only be populated with songs from a local storage device, and may suppress the display of songs stored on remote storage devices.

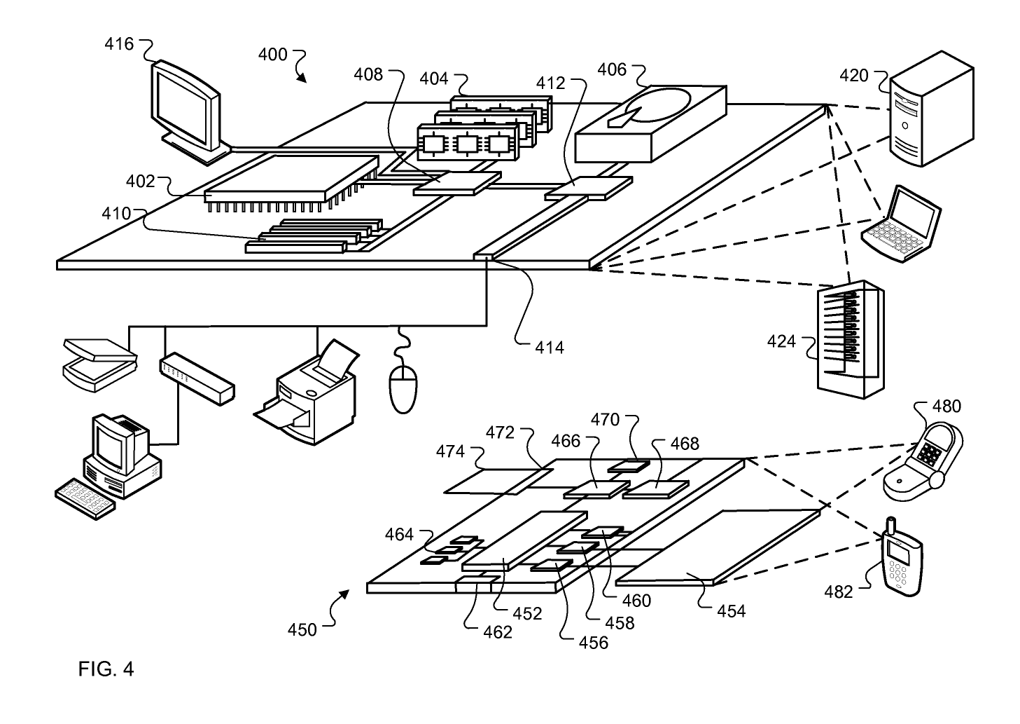

FIG. 4 shows an example of a computing device 400 and a mobile computing device 450 that can be used to implement the techniques described in this disclosure. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine-readable mediums (for example, the memory 404, the storage device 406, or memory on the processor 402).

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device (not shown), such as a mobile computing device 450. Each of such devices may contain one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a non-packable manner.

The memory may include, for example, flash memory and/or NVRAM memory (non-volatile random access memory), as discussed below. In some implementations, instructions are stored in an information carrier that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 468 using a radio-frequency. In addition, short-range communication may occur, such as using a Bluetooth, WiFi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A method performed on one or more computing devices, the method comprising:
receiving a request to present a file inventory on a display associated with the computing device, the file inventory graphically representing a plurality of files stored across two or more physical locations;
accessing a first file stored on a local storage device of the computing device to record first information associated with the first file;
accessing a second file stored on a remote storage device to record second information associated with the second file;
generating the file inventory, the file inventory comprising the first information and the second information; and
presenting the file inventory on the display.

2. The method of claim 1, wherein accessing the second file comprises accessing the remote storage device over a network.

3. The method of claim 1, further comprising accessing a third file stored on the remote storage device to record third information associated with the third file.

4. The method of claim 3, further comprising comparing the first information and the third information to determine a level of similarity between the first file and the third file.

5. The method of claim 4, further comprising:
determining that the level of similarity exceeds a threshold; and
evaluating one or more attributes of the first file against one or more attributes of the third file based on the level of similarity.

6. The method of claim 5, further comprising excluding the third information from the file inventory based on the evaluating.

7. The method of claim 5, wherein the one or more attributes comprise one or more of:
respective speeds with which the first file and the third file can be accessed by the computing device;
respective data qualities of the first file and the third file;
respective recencies of the first file and the third file; and
respective frequencies with which the first file and the third file are accessed.

8. The method of claim 5, wherein the evaluating comprises determining that the computing device is able to access the first file more quickly than the computing device is able to access the third file.

9. The method of claim 8, further comprising causing the computing device to access the first file based on a selection of the first information in the file inventory, the selection comprising an instruction to provide content associated with the first file.

10. The method of claim 1, wherein the first file and the second file comprise music files, video files, image files, and document files.

11. The method of claim 1, wherein the first file and the second file are music files, and the data inventory comprises a library of songs.

12. A method performed on a computing device, the method comprising:
receiving a request to present a file inventory on a display associated with the computing device, the file inventory graphically representing a plurality of files stored across two or more physical locations;
accessing one or more index files that comprises first information associated with a one or more first files stored on a local storage device and second information associated with one or more second files stored on a remote storage device;
recording the first information and the second information;
generating the file inventory, the file inventory comprising the first information and the second information; and
presenting the file inventory on the display.

13. The method of claim 12, wherein the one or more index files comprise one or more extensible markup language (XML) files.

14. A method performed on a computing device that comprises one or more processing devices and one or more local memory devices, the method comprising:
receiving, by the one or more processing devices, a request to present a file inventory on a display associated with the computing device, the file inventory being stored on the one or more local memory devices, and being based on first information associated with a first file stored on the one or more local storage devices and second information associated with a second file stored on a remote storage device, the file inventory graphically representing a plurality of files stored across two or more physical locations; and
presenting the file inventory on the display in response to the request.

15. One or more computer storage devices comprising instructions that, when executed by one or more processing devices, cause the one or more processing devices to perform operations comprising:
receiving a request to present a file inventory on a display associated with the computing device, the file inventory graphically representing a plurality of files stored across two or more physical locations;
accessing a first file stored on a local storage device of the computing device to record first information associated with the first file;
accessing a second file stored on a remote storage device to record second information associated with the second file;
generating the file inventory, the file inventory comprising the first information and the second information; and
presenting the file inventory on the display.

16. One or more computer storage devices comprising instructions that, when executed by one or more processing devices, cause the one or more processing devices to perform operations comprising:
receiving a request to present a file inventory on a display associated with the computing device, the file inventory graphically representing a plurality of files stored across two or more physical locations;
accessing one or more index files that comprises first information associated with a one or more first files stored on a local storage device and second information associated with one or more second files stored on a remote storage device;
recording the first information and the second information;
generating the file inventory, the file inventory comprising the first information and the second information; and
presenting the file inventory on the display.

17. One or more computer storage devices comprising instructions that, when executed by one or more processing devices, cause the one or more processing devices to perform operations comprising:
receiving, by the one or more processing devices, a request to present a file inventory on a display associated with the computing device, the file inventory being stored on the one or more local memory devices, and being based on first information associated with a first file stored on the one or more local storage devices and second information associated with a second file stored on a remote storage device, the file inventory graphically representing a plurality of files stored across two or more physical locations; and
presenting the file inventory on the display in response to the request.
